(19) United States
(12) Patent Application Publication
(10) Pub. No.: US 2003/0140347 A1
(43) Pub. Date: Jul. 24, 2003

(54) Method for transmitting video images, a data transmission system, a transmitting video terminal, and a receiving video terminal

(76) Inventor: Viktor Varsa, Irving, TX (US)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/168,772

(22) PCT Filed: Dec. 14, 2000
(86) PCT No.: PCT/FI00/01092

(30) Foreign Application Priority Data
Dec. 22, 1999 (FI) 19992770

(51) Int. Cl. H04N 7/173; H04B 1/66; H04N 7/12; H04N 11/02

(52) U.S. Cl. 725/90; 375/240.24

(57) ABSTRACT

The invention relates to a method for transmitting video images between video terminals (1, 1′) in a data transmission system. Video images comprise frames (T0, T1,. . . T9), which are divided into slices (S1-S8, SX). Every frame (T0, T1, . . . , T9) comprises at least two slices (S5, S3, S6; S1, SX, S2; S7, S4, S8) which are at least partly adjacent to each other, and consecutive frames (T0, T1, . . . , T9) have corresponding slices (S5, S1, S7; S3, SX, S4; S6, S2, S8). The slices (S1-S8, SX) are interleaved into packets, and the packets are transmitted. The interleaving is performed in such a way that adjacent slices (SX, S1; SX, S2) in the same frame (T1) are transmitted in different packets, and that corresponding slices (S5, S1, S7; S3, SX, S4; S6, S2, S8) of two consecutive frames (T0, T1, T2) of video images are transmitted in different packets. Then every packet comprises only such slices which are other than adjacent to each other in the same frame and other than corresponding slices of two consecutive frames.

A method for transmitting video images, a data transmission system, a transmitting video terminal, and a receiving video terminal

The present invention relates to a method for transmitting video images between video terminals in a data transmission system, in which video images comprise frames, the frames are divided into slices, wherein every frame comprises at least two slices which are at least partly adjacent to each other, and consecutive frames have corresponding slices, the slices are interleaved into packets, and the packets are transmitted. The present invention relates also to a data transmission system, which comprises means for transmitting video images between video terminals, in which video images comprise frames, means for dividing the frames into slices, wherein every frame comprises at least two slices which are at least partly adjacent to each other, and consecutive frames have corresponding slices, the data transmission system comprising further means for interleaving slices into packets, and means for transmitting the packets. The present invention relates furthermore to a transmitting video terminal, which comprises means for transmitting video images, in which video images comprise frames, means for dividing the frames into slices, wherein every frame comprises at least two slices which are at least partly adjacent to each other, and consecutive frames have corresponding slices, the transmitting video terminal comprising further means for interleaving the slices into packets, and means for transmitting the packets. The present invention relates furthermore to a receiving video terminal, which comprises means for receiving video images transmitted in packets, in which video images comprise frames, which are divided into slices, wherein every frame comprises at least two slices which are at least partly adjacent to each other, and consecutive frames have corresponding slices, the receiving video terminal comprising further means for receiving the packets, means for de-interleaving the slices from packets, and means for forming frames from the slices.

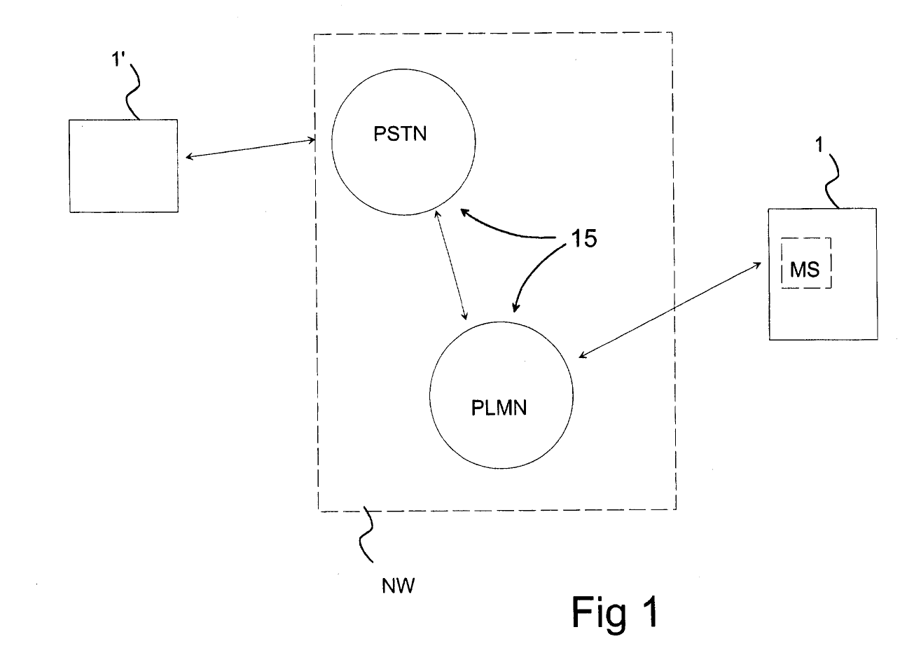

Multimedia applications are used for transmitting e.g. video image information, audio information and data information between a transmitting and receiving multimedia terminal. For data transmission the Internet data network or another communication system, such as a general switched telephone network (GSTN), is used. The transmitting multimedia terminal is, for example, a computer, generally also called a server, of a company providing multimedia services. The data transmission connection between the transmitting and the receiving multimedia terminal is established in the Internet data network via a router. Information transmission can also be duplex, wherein the same multimedia terminal is used both as a transmitting and as a receiving terminal. One such system representing the transmission of multimedia applications is illustrated in the appended FIG. 1.

The video application can be a TV image, an image generated by a video recorder, a computer animation, etc. One video image consists of pixels which are arranged in horizontal and vertical lines, and the number of which in one image is typically tens of thousands. In addition, the information generated for each pixel contains, for instance, luminance information about the pixel, typically with a resolution of eight bits, and in colour applications also chrominance information, e.g. a chrominance signal. This chrominance signal further consists of two components, Cb and Cr, which are transmitted with a resolution of eight bits. On the basis of these luminance and chrominance values, it is possible at the receiving end to form information corresponding to the original pixel on the display device of the video terminal. In said example, the quantity of data to be transmitted for each pixel is 24 bits uncompressed. Thus, the total amount of information for one image amounts to several megabits. In the transmission of a moving image, several images are transmitted per second, for instance in a TV image, 25 images are transmitted per second. Without compression, the quantity of information to be transmitted would amount to tens of megabits per second. However, for example in the Internet data network, the data transmission rate can be in the order of 64 kbits per second, which makes uncompressed real time image transmission via this network impossible.

For reducing the amount of information to be transmitted, different compression methods have been developed, such as MPEG (Motion Picture Experts Group). In the transmission of video, image compression can be performed either as interframe compression, intraframe compression, or a combination of these. In interframe compression, the aim is to eliminate redundant information in successive image frames. Typically, images contain a large amount of such non-varying information, for example a motionless background, or slowly changing information, for example when the subject moves slowly. In interframe compression, it is also possible to utilise motion compensation, wherein the aim is to detect such larger elements in the image which are moving, wherein the motion vector and some kind of difference information of this entity is transmitted instead of transmitting the pixels representing the whole entity. Thus, the direction of the motion and the speed of the subject in question is defined, to establish this motion vector. For compression, the transmitting and the receiving video terminal are required to have such a high processing speed that it is possible to perform compression and decompression in real time.

In several image compression techniques, an image signal converted into digital format is subjected to a discrete cosine transform (DCT) before the image signal is transmitted to a transmission path or stored in a storage means. Using a DCT, it is possible to calculate the frequency spectrum of a periodic signal, i.e. to move from the time domain to the frequency domain. In this context, the word discrete indicates that separate pixels instead of continuous functions are processed in the transformation. In an image signal, neighbouring pixels typically have a substantial spatial correlation. One feature of the DCT is that the coefficients established as a result of the DCT are practically uncorrelated; hence, the DCT effectively conducts the transformation of the image signal from the time domain to the frequency domain.

When the discrete cosine transform is used to compress a single image, a two-dimensional transform is required. Instead of time, the variables are the width and height co-ordinates X and Y of the image. Furthermore, the frequency is not the conventional quantity relating to periods in a second, but it indicates e.g. the rate of change of luminance in the direction of the location co-ordinates X, Y. This is called spatial frequency.

In an image which contains a large number of fine details, high spatial frequencies are present. For example, parallel lines in the image correspond to a higher frequency, the more closely they are spaced. Diagonally directed frequencies exceeding a particular limit can be quantized in image processing more without the quality of the image noticeably deteriorating.

Each frame of the video information is divided into slices. The slice is the lowest independently decodable unit of a video bitstream. The slice layer is also the lowest possible level that allows resynchronization to the data stream in case of transmission errors. The slice contains macroblocks (MB). The slice header contains at least the relative address of the first macroblock of the slice. The macroblock contains usually 16 pixels by 16 rows of luminance sample, the mode information, and the possible motion vectors. For the DCT transform, it is divided into four 8×8 luminance blocks and to two 8×8 chrominance blocks.

Slices can in practical applications have many different forms. For example, a slice can start from the left of the picture and end at the right edge of the picture, or a slice can start anywhere between the edges of the picture. Also the length of the slice need not be the same as the width of the picture but it can also be less than the width of the picture or even more than the width of the picture. Such a slice which does not end in the right edge of the picture continues from the left edge of the picture, one group of blocks lower. Even the size and form of different slices of the picture can be different.

In MPEG-2 compression, the DCT is performed in blocks so that the block size is 8×8 pixels. The luminance level to be transformed is in full resolution. Both chrominance signals are subsampled, for example a field of 16×16 pixels is subsampled into a field of 8×8 pixels. The differences in the block sizes are primarily due to the fact that the eye does not discern changes in chrominance equally well as changes in luminance, wherein a field of 2×2 pixels is encoded with the same chrominance value.

The MPEG-2 defines three frame types: an I-frame (Intra), a P-frame (Predicted), and a B-frame (Bi-directional). The I-frame is generated solely on the basis of information contained in the image itself, wherein at the receiving end, this I-frame can be used to form the entire image. The P-frame is formed on the basis of the closest preceding I-frame or P-frame, wherein at the receiving stage the preceding I-frame or P-frame is correspondingly used together with the received P-frame. In the composition of P-frames, for instance motion compensation is used to compress the quantity of information. B-frames are formed on the basis of the preceding I-frame and the following P- or I-frame. Correspondingly, at the receiving stage it is not possible to compose the B-frame until the corresponding I-frame and P-frame have been received. Furthermore, at the transmission stage the order of these P- and B-frames is changed, wherein the P-frame following the B-frame is received first, which accelerates the reconstruction of the image in the receiver.

Of these three image types, the highest efficiency is achieved in the compression of B-frames. It should be mentioned that the number of I-frames, P-frames and B-frames can be varied in the application used at a given time. It must, however, be noticed here that at least one I-frame must be received at the receiving end, before it is possible to reconstruct a proper image in the display device of the receiver.

In video transmission over such a packet oriented transport system with possible packet losses (e.g. Internet RTP/UDP/IP) one aim is to optimally utilise the available bandwidth for the video information (payload) and at the same time minimise the effect of packet losses. The larger the transport packets are, the smaller is the packet header overhead. However, sending a large amount of video data in one transport packet increases effects of errors if the packet is lost. The optimal trade-off of between packet payload size and packet header overhead can be application environment dependent (e.g. packet loss rate, video bitrate).

Given the output bitstream of a video encoder, a transport packet shall be constructed in an “application layer framing” aware way, which means, that the bitstream is to be chopped at the boundaries of independently decodable video data units (e.g. frame, GOB, slice). This requirement guarantees, that the whole bitstream in a correctly received packet can be utilised (decoded) without dependency on video data included in some other packet that could be lost.

To fulfil this requirement it is still possible to include not only one, but several independently decodable video data units (e.g. several slices, frames) in a packet. Thereby a target packet payload size (optimal in the given application environment) can be maintained independent of the by nature variable bitstream size (in bytes) to code one independently decodable video data unit.

Prior art solutions are either not concerned by the packet header overhead and only one independently decodable video data unit such as a slice or a frame is put into a packet, or so much continuous video bitstream (sequence of independently decodable video data units) is put into a packet, that a reasonable packet size is attained.

The packetization method in which one or more sequential slice/frame (independently decodable video data unit) is put into one packet has poor rate-distortion performance, because it results in unreasonable small packet sizes and therefore large packet header overhead if the covered frame/sequence area is kept small. Otherwise, if the packet size is targeted to be large, such a packetization method results in loss of a too large frame/sequence area which is difficult to conceal.

There are some prior art solutions which interleave slices of one frame into two or more packets, e.g. odd slices of a frame are put into one packet and even slices of a frame are put into another packet. The spatial interleaving of slices method can be treated as a low-latency restricted version of the general spatio-temporal interleaving, and therefore the interleaving pattern is not optimal for easing concealment.

The present invention describes a method to construct a packet from several independently decodable video data units in a way, that loss of a packet doesn't cause loss of too large spatio-temporally continuous area of a video frame/sequence for efficient concealment.

One purpose of the present invention is to produce a method and a system, in which possible errors in packet transmission does not deteriorate the quality of the video signal as much as in prior art systems. The present invention is primarily characterized in that the interleaving is performed in such a way that adjacent slices) in the same frame are transmitted in different packets, and that corresponding slices of two consecutive frames of video images are transmitted in different packets, wherein every packet comprises only such slices which are neither adjacent to each other in the same frame nor corresponding slices of two consecutive frames. The data transmission system according to the present invention is primarily characterized in that the interleaving is arranged to be performed in such a way that adjacent slices in the same frame are arranged to be transmitted in different packets, and that corresponding slices of two consecutive frames of video images are arranged to be transmitted in different packets, wherein every packet comprises only such slices which are neither adjacent to each other in the same frame nor corresponding slices of two consecutive frames. The transmitting video terminal according to the present invention is primarily characterized in that the interleaving is arranged to be performed in such a way that adjacent slices in the same frame are arranged to be transmitted in different packets, and that corresponding slices of two consecutive frames of video images are arranged to be transmitted in different packets, wherein every packet comprises only such slices which are neither adjacent to each other in the same frame nor corresponding slices of two consecutive frames. The receiving video terminal according to the present invention is primarily characterized in that the de-interleaving the slices from packets is arranged to be performed in such a way that adjacent slices in the same frame are received in different packets, and that corresponding slices of two consecutive frames of video images are received in different packets, wherein every packet comprises only such slices which are neither adjacent to each other in the same frame nor corresponding slices of two consecutive frames.

Considerable advantages are achieved with the present invention when compared with solutions of prior art. With a method according to the invention, it is also possible to reduce artefacts in decoded video signal which are due to errors in packet transmission. If one packet is corrupted so that error correction of the decoder can't correct the packet information, there can still be uncorrupted packets which contains information of adjacent slices of the corrupted slice. The decoder may then use that information to conclude what the lost information could be. Often the details of the video image does not change very rapidly in vertical and horizontal directions of the image.

### In the following, the invention will be described in more detail with reference to the appended figures, in which

FIG. 1 shows a structure of a video transmission system,

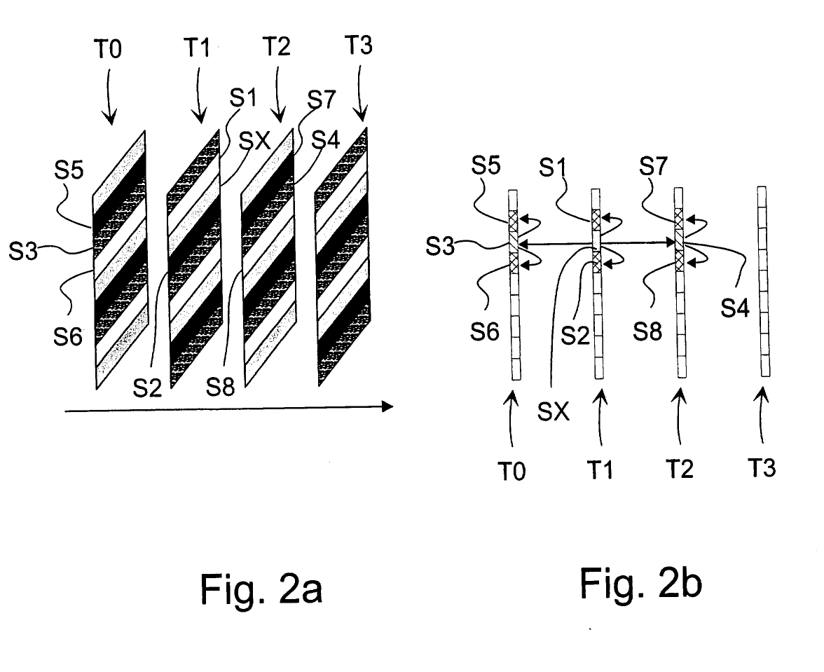

FIG. 2a shows the no-neighbour principle of the interleaving method of the present invention,

FIG. 2b shows an advantageous embodiment of the interleaving method of the present invention,

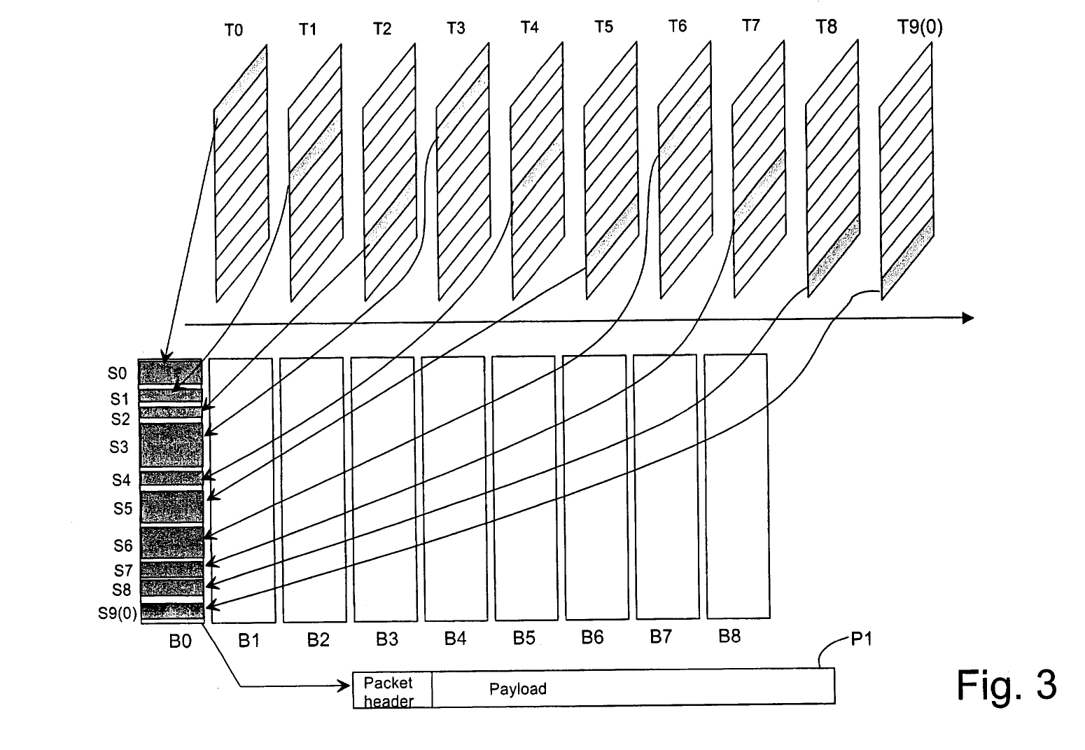

FIG. 3 shows another advantageous embodiment of the interleaving method of the present invention,

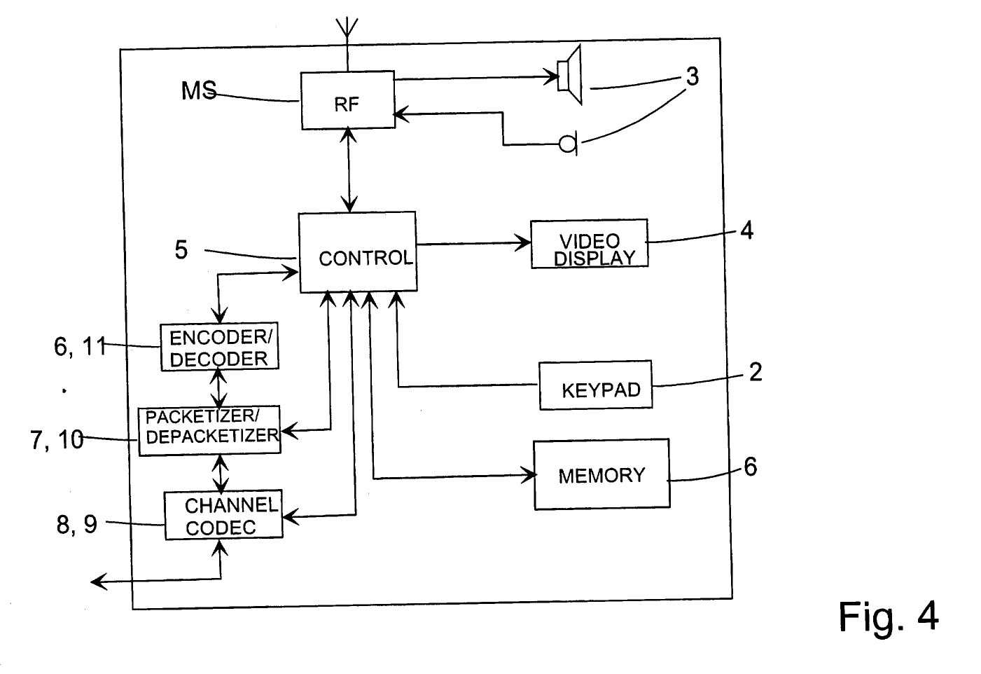

FIG. 4 shows a video terminal according to an advantageous embodiment of the invention in a reduced block diagram,

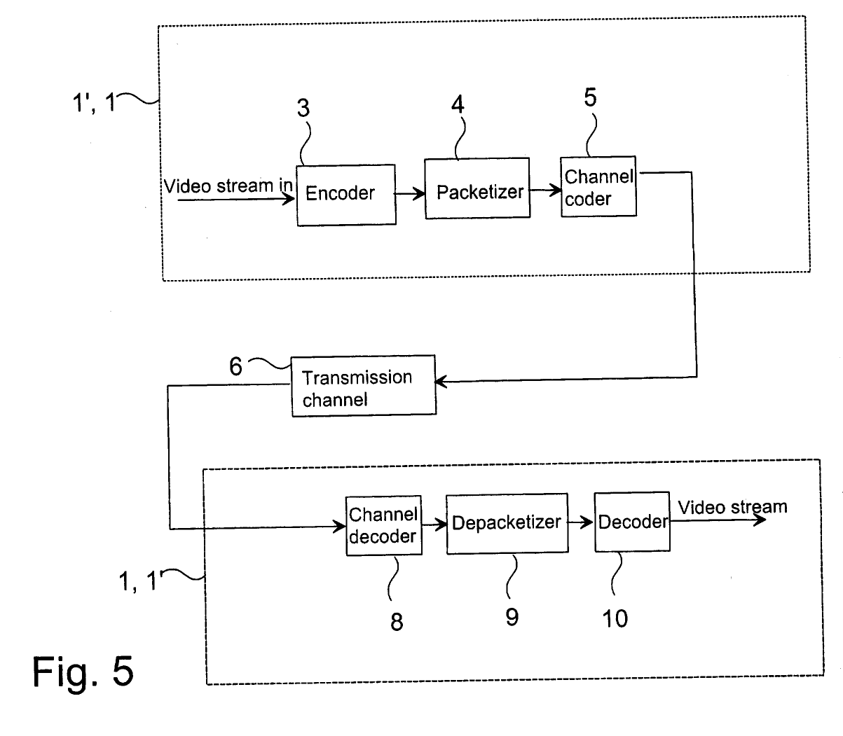

FIG. 5 shows a video transmission system according to an advantageous embodiment of the invention in a reduced block diagram,

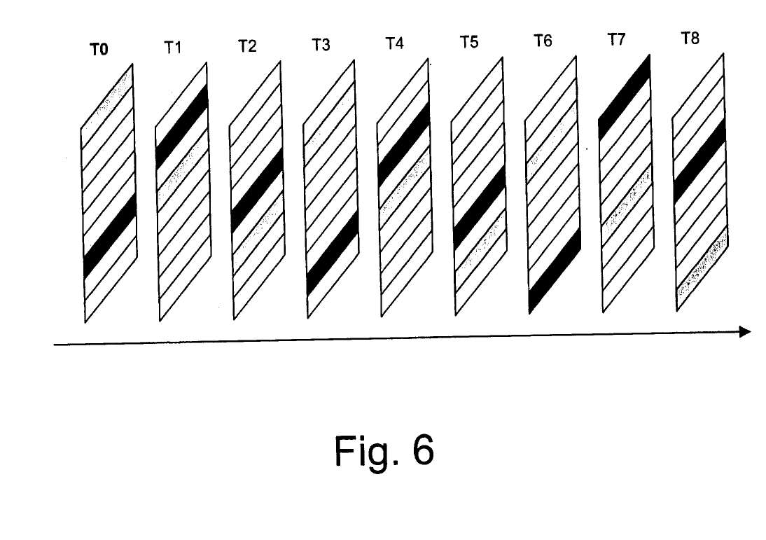

FIG. 6 shows a situation where one packet is corrupted and another is received properly, and

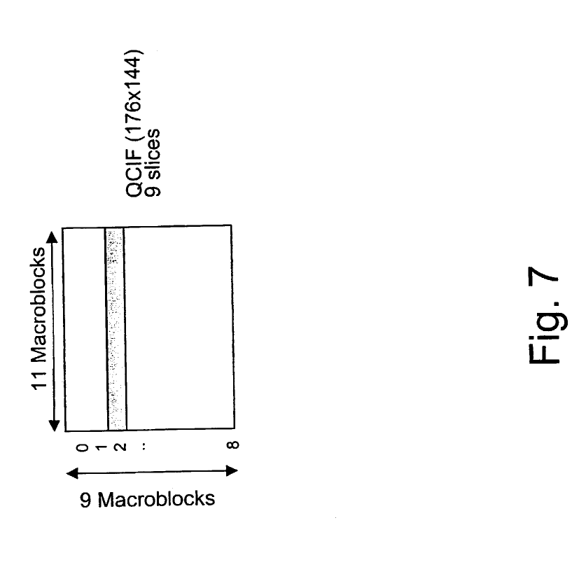

FIG. 7 shows a video sequence with a known QCIF frame size, and

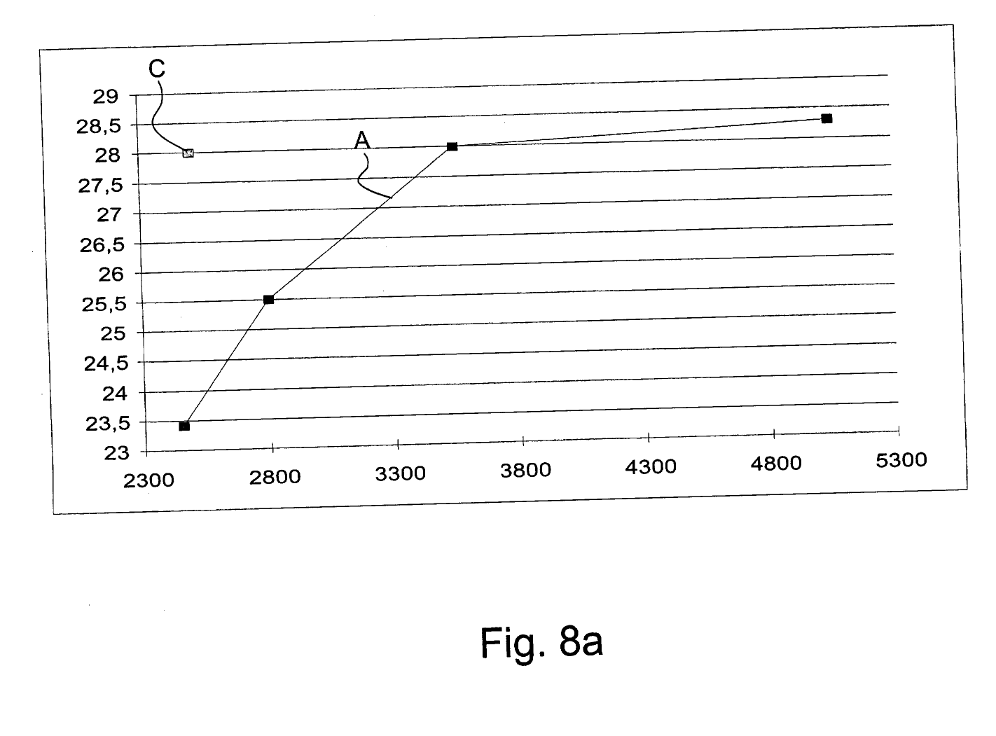

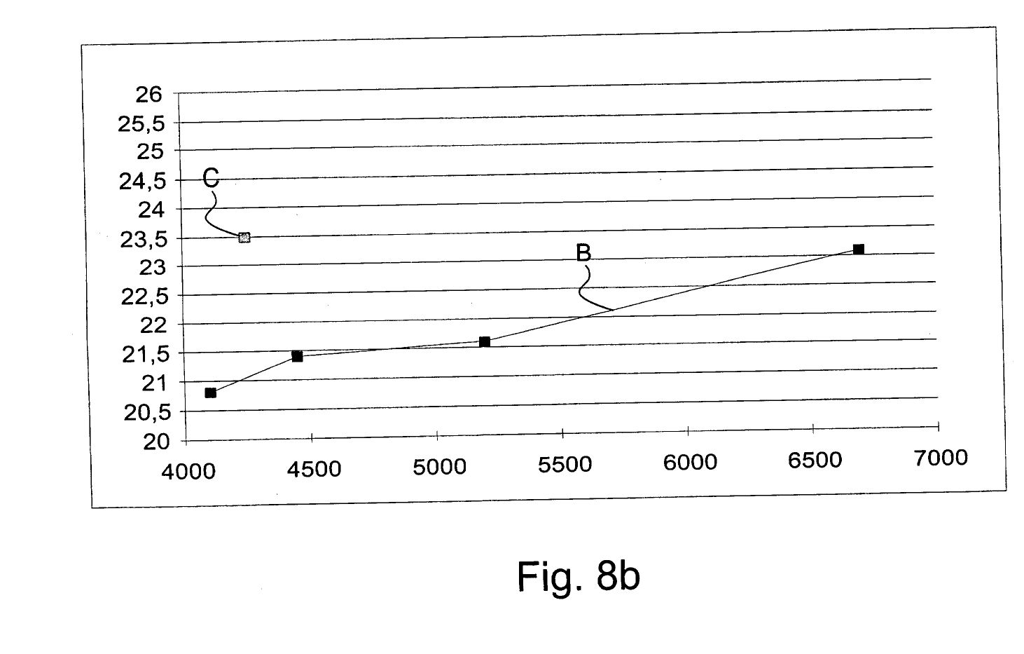

FIGS. 8a and 8b show average bits/frame vs. PSNR.

A data transmission system, such as that presented in FIG. 1, comprises a user video terminal 1, a service provider video terminal 1′, and a transmission network NW, such as a telecommunication network. It is obvious that in practical applications there are several user video terminals 1 and several service provider video terminals 1′, but with respect to understanding the invention, it is sufficient that the invention is described by means of these two video terminals 1, 1′. Between the user video terminal 1 and the service provider video terminal 1′, preferably a duplex data transmission connection is established. Thus, the user can transmit, for instance, information retrieval addresses and control commands to the data transmission network NW and to the service provider video terminal 1′. Correspondingly, from the service provider video terminal 1′ it is possible to transmit, for instance, information on video applications to the user video terminal 1.

The block diagram in FIG. 4 presents the video terminal 1, 1′ according to an advantageous embodiment of the invention in a reduced manner. The terminal in question is suitable for both transmitting and receiving, but the invention can. also be applied in connection with simplex terminals. In the video terminal 1, 1′ all the functional features presented in the block diagram of FIG. 4 are not necessarily required, but within the scope of the invention it is also possible to apply simpler video terminals 1, 1′, for example without keyboard 2 and audio means 3. In addition to said keyboard 2 and audio means 3 the video terminal also comprises video means 4, such as a video monitor, a video camera or the like. The audio means 3, advantageously comprise a microphone and a speaker/receiver, which is known as such. If necessary, the audio means 3 also comprises audio amplifiers.

To control the functions of the video terminal 1, 1′ it comprises a control unit 5, which consists, for example, of a micro controlling unit (MCU), a micro processing unit (MPU), or the like. In addition, the control unit 5 contains memory means MEM e.g. for storing application programs and data and bus interface means I/O for transmitting signals between the control unit 5 and other functional blocks. The video terminal 1,1′ also comprises an encoder 6, which encodes and compresses the video information into bit stream. The compression is e.g. based on DCT transform and quantization, wherein in decompression phase the received information is dequantized and inverse DCT transformed, which is known as such. The bit stream is advantageously saved in the encoder 6 in slices. Bit stream from encoder 6 is provided to a packetizer 7, which performs the interleaving as will be explained later. Further, the video terminal comprises channel coder 8, which performs the channel coding for the information to be transmitted to the transmission network NW. A channel decoder 9 performs the channel decoding for the information received from the transmission network NW. A depacketizer 10 performs the de-interleaving of the channel decoded video information. An decoder 11 decodes and decompresses the video information from the bit stream output from the depacketizer 10.

In the transmitting terminal, a video encoder 6 conducts the formation of data frames of a video signal to be transmitted, for example, an image produced by a video camera. Some video encoding methods are defined. In the receiving terminal, the procedure is reversed, i.e. an analogue video signal is produced from the video data frames, which is then transmitted, for example, to a monitor or to another display device.

The transmission network NW is such that it supports packet based communication. As a transmission network, for example a general switched telephone network 15 is used, part of which can be a wireless telecommunication network, such as a public land mobile network, PLMN.

The proposed slice interleaving method is explained in this document on video sequence with QCIF frame size as shown in FIG. 7. It is easily extendible to other frame sizes as well.

In order to explain the operation of the method according to an advantageous embodiment of the present invention, a slice is defined to have one row of macroblocks of a frame, but this invention is not restricted only to that kind of slices but they can also have other forms as was described earlier in this description. When loosing a slice of this shape all the lost macroblocks have two reliable neighbours (below and above) which was probably found to be sufficient to perform a good enough concealment. The algorithm in general could handle other shape of slices as well, for example half row of macroblocks, the constraint is only to have the same slicing in all consecutive frames that interleaving can be applied.

In the following, the operation of the video terminal 1′ according to an advantageous embodiment of the invention at the transmission stage in video signal transmission is presented referring to the block diagram of the transmission system in FIG. 5. The steps of the method can advantageously be applied in the software of the control unit 5. The control unit 5 controls the operational blocks of the video terminal 1, 1′.

The video encoder 6 constructs compressed information (bit stream) of macro blocks of video frames of the video source and save them as slices in the memory. This information also comprises preferably information of the location of each slice, e.g. location of the first macro block of the slice.

For the packetization there is selected an interleaving pattern, which the packetizer 7 utilises when it forms the packets. The interleaving pattern is known by both the transmitting video terminal 1′ and the receiving video terminal 1. The no neighbour conditions provides the concealment algorithm the best circumstances to recover the lost frame area as good as possible when a packet is lost. Then, the slices included in one transport packet should not be (listed in the order of priority): Spatial neighbours, Temporal neighbours, nor Spatial neighbours of temporal neighbours.

Reasoning for temporal neighbours and spatial neighbours of temporal neighbours is that when a packet is lost there shouldn't be slices from consecutive frames lost at the same position, or at the next/previous position. This is important as the motion is typically small, which means that the previous frame's same/near pixel positions are used in temporal concealment. If the area in the previous frame from where the concealment predicts would be lost as well we implicitly introduced error propagation.

In FIG. 2a there is shown a diagram of the no-neighbour principle. In FIG. 2a the slice SX describes one slice of a packet. The other coloured slices S1-S8 describe those slices of the same frame T1 and of the two adjacent frames T0, T2 of the frame T1, which must not be transmitted in the same packet as the slice SX, i.e. they do not fulfil the no-neighbour principle in spatial and temporal directions. The minimum slice interleaving pattern that fulfils the “no neighbour” conditions is shown in FIG. 2b. There are four bins where each slice can be selected. Four spatially consecutive slices go to the four different bins. Co-located slices of two consecutive frames go to bins shifted by two. It is obvious that the frame numbers T0-T3 and slice numbers S1-S8, SX are presented as non-limiting examples only.

In FIG. 3 there is shown a preferable interleaving pattern of the present invention. The video terminal 1, 1′ comprises a number of storage areas, which are also called bins B0-B8 in this description. The bins B0-B8 are formed to temporary store the information of the slices before forming packets from the slices. The bins B0-B8 can advantageously be formed into memory means 6 of the video terminal 1, 1′, which is known as such. Each slice of one frame is put into a different bin B0-B8 and different slices of each consecutive frames are put into a bin B0-B8. In case of nine slices this means that there are nine bins B0-B8 each of them containing a differently positioned slice from maximum nine following frames T0-T8. The selection of the bin B0-B8 where a slice is put is based on the interleaving pattern, which can be written as a string: “T0S0, T1S3, T2S6, T3S1, T4S4, T5S7, T6S2, T7S5, T8S8”, where T means frame time reference and S means slice number. This pattern means that first bin B0 contains the first slice (S0) from the first frame (T0), the fourth slice (S3) from the second frame (T1), and so on to the ninth slice of the ninth frame. These slices are presented as gray coloured slices in the FIG. 3. Other slices of the frames are interleaved into bins B0-B8 according to the same pattern by shifting the pattern accordingly. For example, the second bin B1 contains the first slice of the second frame, the fourth slice from the third frame, and so on to the ninth slice of the first frame. The first slice of the tenth frame T9 is put into the first bin B0, and so on. This packetization pattern uses nine frames and nine slices in each frame but it is obvious that the present invention is not restricted to only such patterns. After nine frames the pattern is started from the beginning again. This interleaving method is also shown in the FIG. 3.

Packets to be channel coded and sent to the transmission network NW are formed from the contents of the bins B0-B8, i.e. slices. Generally the slices put into one packet can be from any spatial position and any frame (temporal position) as long as the above conditions are fulfilled. In practice there are some constraints that influence the operation of the packetizer 7 when forming packets from the slices stored into bins B0-B8. Target size of the packet puts a limit on how many slices are put into one packet. In an application in which slices include always the same amount of macroblocks (e.g. one line), the slice size in bytes varies according to the activity of the corresponding frame area: higher motion means larger slice size, static image means small slice size. When deciding to which packet to put a certain slice the size information could also be considered which is described later in this description.

Another constraint that influence the operation of the packetizer 7 is maximum allowed delay, which constrains the temporal width of the interleaving pattern: to how many frames the slices of a packet belong. The decoder can start decoding a frame, when the bitstream of all the slices in a frame have arrived, or are declared to be lost. If the temporal width of the interleaving pattern is too big, the decoder has to keep many frames' bitstream in its buffer before processing it.

A further constraint that influence the operation of the packetizer 7 is readiness to combat loss of consecutive packets. This requires a design, that when two or more consecutive transport packets are lost, the missing slices don't build a pattern that is against the above conditions. In practical applications the packetizer 7 can only handle a limited number of lost packets.

When the completed condition is fulfilled for a bin there are alternative ways how to handle the rest of the bins, with which the completed condition is not yet fulfilled. These alternative ways are described later in this description.

The slice interleaving packetization therefore is most useful in an application environment where large packets are used, and the delay can be large as well: e.g. streaming over IP (Internet).

In the following a packetization algorithm as seen at the output of the encoder 6 will be described with reference to the video terminal 1, 1′ in FIG. 4 and the transmission system in FIG. 5. In the following it is assumed that slice number 2 of frame 1 is currently to be encoded. The interleaving pattern used in this example is “T0S0, T1S3, T2S6, T3S1, T4S4, T5S7, T6S2, T7S5, T8S8”. The packetizer 7 takes slices from encoder 6 preferably slice by slice and stores them into bins. For every slice the packetization algorithm is performed in the packetizer 7. When using this interleaving pattern the packetizer 7 takes the current slice number (e.g. 2), and gets the pattern relative frame number (0=the frame containing the 0th slice) using the interleaving pattern (e.g. T6S2 →6), wherein the selected bin number is got by subtracting the pattern relative frame number (e.g. 6) from current frame number in the 9 frame group (e.g. 1) modulo 9 (e.g. (1-6) mod 9=−5=4). The present slice interleaving pattern is nine periodic, which means, that after nine frames the interleaving pattern is repeated.

The packetizer 7 takes next slice from the encoder 6 and selects the bin where to put the present slice according to the interleaving pattern. Then, the packetizer 7 examines if “completed” condition of the bin is fulfilled. If the condition is fulfilled, then the packetizer forms a packet from the contents of the bin, and sends the packet to the channel coder 8 for channel coding and transmission to the transmission network NW.

However, if the “completed” condition is not yet fulfilled, the packetizer 7 examines, if the video stream still continues. If so, the packetizer 7 loops back to the beginning to take next slice from encoder 6. When the video stream ends, the packetiser 7 empties all the bins, i.e. forms separate packets from the contents of the bins B0-B8, and sends all the packets to the channel coder 8.

The completed condition may comprise a maximum slice amount in a packet and/or the size of the packets is limited. When the size of slices in a bin B0-B8 achieves the target size of a packet, that bin B0-B8 is declared completed, a packet is formed from the contents of that bin B0-B8, and the packet is sent. Preferably, the completed condition is also influenced by the maximum allowed delay at the decoder. There is also a maximum temporal width what a packet can cover: if the first slice in the bin and the last slice of a bin has a temporal reference difference more than a predefined maximum it is preferably declared completed (regardless of its size), a packet is formed and sent.

To handle the case of packet loss bursts, the transmission order of the packets could be chosen so, that the loss of two (or more) consecutive packets cause the least violation of “no neighbour” conditions. If the rule is set up so that two consecutive transport packets should include slices according to the interleaving pattern where the pattern is shifted by two frames, the next packet uses the interleaving pattern of T0S6, T1S1, T2S4, T3S7, T4S2, T5S5, T6S8, T7S0, T8S3. If there is no target packet size constraint defined and these two consecutive packets over the nine frames are lost, the affected nine frames will loose the slices marked as black slices in FIG. 6. Still the temporal error propagation considerations are respected.

The previously introduced design constraints are mapped to the parameters of target packet size, and max temporal width of a packet for the proposed interleaving pattern as following:

If the max temporal width of a packet is defined to be nine, then the “no temporal neighbour” condition is valid through all the slices in a packet. Unless the target packet size constraint declared a slice completed before the max temporal width is reached, one packet has one slice from each consecutive nine frames and for nine frames there is nine packets transmitted. The next group of nine frames is interleaved in the next sequence of packets.

A packet is preferably declared completed when the target packet size is reached.

In the above discussion a bin was completed when the max temporal width (9) was reached, and therefore the periodicity of nine packet/nine frame groups. If the target packet size is exceeded before the max temporal width is reached, the target size exceeding bin has to be declared completed. By introducing this new constraint for completing bins it is not possible to maintain the previously defined packet sending order any longer (to handle packet loss bursts), as the sending order gets random, depending on the size of the slices.

The target packet size can advantageously be defined as the average coded frame size. This is actually the average transport packet size get by using only the temporal width constraint (temporal width=9 && number of slices in frame=9). Simulations has shown that setting the target packet size larger than that doesn't constrain creating packets that include many large (in bytes=“difficult to code”) slices, which means, that if one of this larger than average transport packet is lost it is very difficult to conceal. Setting the target packet size smaller than that decreases the temporal width of a packet, which means, that the “no neighbour” conditions are not so well reflected in case of packet loss bursts or higher packet loss rates. The new packet is started without the interleaving pattern to be reinitialised, only the temporal width counter is reset.

If the packets can be prioritised in the transport protocol (e.g. re-transmission of higher priority packets) the packetization algorithm should be aware of this. The most obvious mapping of transport prioritisation in a video bitstream is frame type (I,P,B) prioritisation, which is based on the idea, that different frame types are of different importance for video reconstruction. Therefore packets containing slices of different frame types are prioritised differently. Interpreting this in a slice interleaving algorithm means, that the interleaving pattern should collect slices from only same frame types. For Intra frames therefore a separate interleaving pattern could be used.

An Intra frame is coded independently of any previous frame, which means, that the concealment algorithm can also be assumed to use only spatial information for concealing lost Intra frame macroblocks. This gives a possibility to reduce the “no neighbour” conditions to no spatial neighbour requirement for slices in the same packet. The resulting simplest interleaving pattern is such that every other slice of a frame, e.g. odd numbered slices, are put into one bin and every other slice of a frame, e.g. even numbered slices, are put into another bin. If a bin doesn't exceed the still valid constraint on target packet size this Intra interleaving pattern creates 2 packets for a frame including the odd and even slices separately.

Further, in a situation where the “completed” condition is fulfilled to a bin, there can exist alternative ways to implement the invention. Only that bin (bin B0 in the example of FIG. 3) which fulfils the condition is sent, or all bins B0-B8 irrespective of the status of other bins B1-B8 are sent. If only that bin B0 which fulfils the condition is sent, then the method of an advantageous embodiment of the present invention comprises further the following steps. The packetizer 7 completes just the single bin B0 in question, forms a packet P1 (FIG. 3), and sends it to the channel coder 8. The interleaving pattern is not be reinitialised, only the temporal width of the completed bin B0. This way the covered frame groups by each packet become random after a longer time of operation. This is the method assumed in the description above.

If all bins B0-B8 irrespective of the status of other bins B1-B8 are sent, then the method of another advantageous embodiment of the present invention comprises further the following steps. The packetizer 7 completes all the pending bins B0-B8, forms packets from the contents of the bins B0-B8, and sends the packets to the channel coder 8. Then the sending order can be maintained and a new frame group can be started (interleaving pattern also reinitialised), but the packet sizes of the other packets can be smaller than optimal.

The interleaving algorithm can slightly be modified: The size of all bins B0-B8 is checked when the last slice of a frame is processed (a packet is selected for it). If the largest of the nine exceeded a predefined threshold, the completed condition is automatically fulfilled for all bins B0-B8. In this case all of the nine bins B0-B8 contains a slice of only the already processed frames (smaller than nine).

The interleaving pattern doesn't necessarily have to be fixed during the whole operation. The decision to which bin B0-B8 to put a just encoded slice could be made adaptively, for example based on the size of the packet. This introduces some problems at the decoder, that it can not for sure say, that a slice is lost given a packet is lost, as it doesn't know in advance which slices were in a packet. There has to be a constraint on the interleaving pattern (e.g. in how many consecutive transport packets the slices belonging to one frame can be spread), that the decoder can assume after receiving a certain number of packets a slice loss, and can start decoding a frame.

The goal of the simulation was to test the performance of the proposed slice interleaving algorithm compared to one slice/one packet approach. The plots of the FIGS. 8a, 8b show average bits/frame vs. PSNR. The different bits/frame values in the one slice/one packet packetization case result from the different slice sizes used (1, 2, 3 and 5 lines of MBs per slice), thereby the number of packets needed for the whole sequence, and thereby the different amount of transport packet header overhead for a frame. So, the smaller the packet size is the more packets need to be sent, the more is the transport packet header overhead, the higher is the average bits/frame.

The PSNR values vary corresponding to how difficult the lost part of the frame was to be concealed for the concealment algorithm. In the interleaving algorithm's PSNR is expected to be better if the “no neighbour” conditions are better reflected. In the one slice/one packet approach (according to previous experiments) smaller slice size (less macroblocks in a slice) results in better performance.

Simulation conditions were:

Sequences used: 7% and 15% with QP=16 for Intra, Inter (no rate control).

The encoder used Adaptive Intra Refresh algorithm to stop error propagation in the reconstructed sequence by forcing Intra macroblock for the difficult to code macroblocks. The number of forced Intra macroblocks per frame was maximised as six.

The transport packet size was controlled

in 1 slice/1 packet mode by the number of macroblock lines included in 1 slice. The 4 different slice sizes were 1,2,3 and 5 lines of macroblocks in 1 slice.

in interleaving mode by the number of 1-macroblock-line/slice slices put into a transport packet. The target packet size was set for each sequence to the average coded frame size.

A 40 byte header is calculated for a transport packet (RTP/UDP/IP).

The loss patterns were hand generated for a certain average packet loss rate (7%, 15%, etc.) The 7% loss pattern didn't contain packet loss bursts, the 15% loss pattern had two-packet long bursts.

It is proven, that the packet header overhead is reduced efficiently by using the proposed interleaving algorithm, while maintaining better or same PSNR as the one slice/one packet approach with one line of MBs/ one slice.

In the following, the results of the simulations are briefly analysed. Interleaving pattern is spatio-temporal and is spatial and temporal error concealment aware, i.e. “no neighbour” conditions are fulfilled. Looking at the plot A of FIG. 8a and plot B of FIG. 8b only for smaller packet loss rates (without packet loss burst) and small slice (1 line MB/ 1 slice) can the 1 slice/1 packet packetization (reference point C) reach similar PSNR values as of the interleaving method, but with the price of large packet header overhead. This shows, that loosing slices according to the proposed interleaving pattern, especially for burst packet losses, is better than loosing individual slices according to a “random” pattern (the packet loss pattern), and justifies the “no neighbour” conditions.

The slice interleaving method can be used with any video compression algorithm, that is macroblock (MB) based and supports sub-frame application layer framing (ALF). ALF requires, that packets must be constructed consistent with the structure of the coding algorithm, in that only full independently decodable video data units are put into packets (a unit is not divided into several packets). The interleaving method according to the present invention operates with units, that are smaller than a frame, but larger than 1 macroblock (e.g. H.263 GOB (Group of Blocks) slice; MPEG-4 Video Packet; MVC slice).

Furthermore, in connection with the video terminal 1,1′ it is possible to use a wireless communication device MS, wherein data transmission can be conducted at least partly in a wireless manner. Also, at least some of the functions of the video terminal 1 can be implemented by using the operational blocks of such a wireless communication device MS. As an example of the wireless station, Nokia 9000 Communicator should be mentioned, which comprises, for instance, memory means, a display device, modem functions and a control unit, wherein it is possible to implement the video terminal 1 according to a preferred embodiment of the invention in most respects by modifications made in the application software of the wireless communication device.

The present invention is not solely restricted to the above presented embodiments, but it can be modified within the scope of the appended claims.

1. A method for transmitting video images between video terminals (1, 1′) in a data transmission system, in which video images comprise frames (T0, T1, . . . , T9), the frames are divided into slices (S1-S8, SX), wherein every frame (T0, T1, . . . , T9) comprises at least two slices (S5, S3, S6; S1, SX, S2; S7, S4, S8) which are at least partly adjacent to each other, and consecutive frames (T0, T1, . . . , T9) have corresponding slices (S5, S1, S7; S3, SX, S4; S6, S2, S8), the slices (S5-S8, SX) are interleaved into packets, and the packets are transmitted, characterized in that the interleaving is performed in such a way that adjacent slices (SX, S1; SX, S2) in the same frame (T1) are transmitted in different packets, and that corresponding slices (S5, S1, S7; S3, SX, S4; S6, S2, S8) of two consecutive frames (T0, T1, T2) of video images are transmitted in different packets, wherein every packet comprises only such slices which are other than adjacent to each other in the same frame and other than corresponding slices of two consecutive frames.

2. The method according to claim 1, characterized in that adjacent slices of corresponding slices of consecutive frames are transmitted in different packets.

3. The method according to claim 1 or 2, characterized in that at least two storage areas (B0-B8) are formed, and that interleaving slices into packets comprises steps for selecting one of said storage areas (B0-B8) for each slice, temporarily storing each slice into said selected storage area (B0-B8), and forming packets of slices temporarily stored in storage areas (B0-B8), respectively.

4. The method according to claim 3, characterized in that constraints are defined for packets.

5. The method according to claim 4, characterized in that at least one packet is formed of slices temporarily stored in respective storage area (B0-B8), when said constraint for said packet is fulfilled.

6. The method according to claim 4 or 5, characterized in that the quantity of information in the packet is limited.

7. The method according to claim 4, 5 or 6, characterized in that the quantity of the slices in the packet is limited.

8. The method according to any one of the claims 1 to 7, in which video images are divided into macroblocks, which are compressed and quantized prior transmission, characterized in that the slices comprises compressed and quantized information of said macroblocks.

9. The method according to any one of the claims 1 to 8, characterized in that the interleaving is performed according to an interleaving pattern with “T0S0, T1S3, T2S6, T3S1, T4S4, T5S7, T6S2, T7S5, T8S8”, where T means frame time reference modulo 9, and S means slice number of the frame.

10. A data transmission system, which comprises
means (NW) for transmitting video images between video terminals (1, 1′), in which video images comprise frames,
means (6) for dividing the frames into slices (S1-S8, SX), wherein every frame (T0, T1, . . . , T9) comprises at least two slices (S5, S3, S6; S1, SX, S2; S7, S4, S8) which are at least partly adjacent to each other, and consecutive frames (T0, T1, . . . , T9) have corresponding slices (S5, S1, S7; S3, SX, S4; S6, S2, S8),
means (7) for interleaving slices (S1-S8, SX) into packets, and
means (8) for transmitting the packets,
characterized in that the interleaving is arranged to be performed in such a way that adjacent slices (SX, S1; SX, S2) in the same frame (T1) are arranged to be transmitted in different packets, and that corresponding slices (S5, S1, S7; S3, SX, S4; S6, S2, S8) of two consecutive frames (T0, T1, T2) of video images are arranged to be transmitted in different packets, wherein every packet comprises only such slices which are other than adjacent to each other in the same frame and other than corresponding slices of two consecutive frames.

11. The data transmission system according to claim 10, which comprises means (NW) for receiving video images transmitted in packets, in which video images comprise frames, means (8) for 5 receiving the packets, means (7) for de-interleaving the slices (S1-S8, SX) from packets, and means (6) for forming frames from the slices (S1-S8, SX), characterized in that de-interleaving the slices (S1-S8, SX) from packets is arranged to be performed in such a way that adjacent slices (SX, S1; SX, S2) in the same frame (T1) are received in different packets, and that corresponding slices (S5, S1, S7; S3, SX, S4; S6, S2, S8) of two consecutive frames (T0, T1, T2) of video images are received in different packets, wherein every packet comprises only such slices which are other than adjacent to each other in the same frame and other than corresponding slices of two consecutive frames.

12. The data transmission system according to claim 10 or 11, characterized in that adjacent slices of corresponding slices of consecutive frames are transmitted in different packets.

13. The data transmission system according to claim 10, 11 or 12, characterized in that it comprises at least two storage areas (B0-B8), and means for interleaving slices (S1-S8, SX) into packets comprises means (5) for selecting one of said storage areas (B0-B8) for each slice, means (5, 6) for temporarily storing each slice into said selected storage area (B0-B8), and means (5) for forming packets of slices temporarily stored in storage areas (B0-B8), respectively.

14. A transmitting video terminal (1, 1′), which comprises
means (NW) for transmitting video images, in which video images comprise frames, means (6) for dividing the frames into slices (S1-S8, SX), wherein every frame (T0, T1, . . . , T9) comprises at least two slices (S5, S3, S6; S1, SX, S2; S7, S4, S8) which are at least partly adjacent to each other, and consecutive frames (T0, T1, . . . , T9) have corresponding slices (S5, S1, S7; S3, SX, S4; S6, S2, S8),
means (7) for interleaving the slices (S1-S8, SX) into packets, and
means (8) for transmitting the packets,
characterized in that the interleaving is arranged to be performed in such a way that adjacent slices (SX, S1; SX, S2) in the same frame (T1) are arranged to be transmitted in different packets, and that corresponding slices (S5, S1, S7; S3, SX, S4; S6, S2, S8) of two consecutive frames (T0, T1, T2) of video images are arranged to be transmitted in different packets, wherein every packet comprises only such slices which are other than adjacent to each other in the same frame and other than corresponding slices of two consecutive frames.

15. A receiving video terminal (1, 1′), which comprises
means (NW) for receiving video images transmitted in packets, in which video images comprise frames, which are divided into slices (S1-S8, SX), wherein every frame (T0, T1, . . . , T9) comprises at least two slices (S5, S3, S6; S1, SX, S2; S7, S4, S8) which are at least partly adjacent to each other, and consecutive frames (T0, T1, . . . T9) have corresponding slices (S5, S1, S7; S3, SX, S4; S6, S2, S8),
means (8) for receiving the packets,
means (7) for de-interleaving the slices (S1-S8, SX) from packets, and
means (6) for forming frames from the slices (S1-S8, SX),
characterized in that the de-interleaving the slices (S1-S8, SX) from packets is arranged to be performed in such a way that adjacent slices (SX, S1; SX, S2) in the same frame (T1) are received in different packets, and that corresponding slices (S5, S1, S7; S3, SX, S4; S6, S2, S8) of two consecutive frames (T0, T1, T2) of video images are received in different packets, wherein every packet comprises only such slices which are other than adjacent to each other in the same frame and other than corresponding slices of two consecutive frames.
